(19) United States
(12) Patent Application Publication
(10) Pub. No.: US 2021/0279803 A1
(43) Pub. Date: Sep. 9, 2021

(54) INFORMATION PROVIDING DEVICE

(71) Applicant: HONDA MOTOR CO., LTD., Tokyo (JP)

(72) Inventor: Shigeru NAMIKI, Saitama (JP)

(21) Appl. No.: 17/179,420

(22) Filed: Feb. 19, 2021

(30) Foreign Application Priority Data
Mar. 6, 2020 (JP) 2020-038507

(51) Int. Cl. G06Q 40/06; B60L 53/60

(52) U.S. Cl. CPC G06Q 40/06; B60L 53/60

(57) ABSTRACT

Provided is an information providing device capable of adding financial value to a secondary battery. An information providing device 200 includes: a management unit 211 that manages price information relating to price of a financial product relating to a secondary battery; a first calculation unit 212 that calculates a first price of the financial product traded on a first date based on the price information; a second calculation unit 213 that calculates a second price of the financial product traded on a second date based on the price information; a difference calculating unit 214 that calculates a difference between the first price and the second price, and a cost determination unit 215 that determines a vehicle-related cost relating to a vehicle using the secondary battery based on the difference.

This application is based on and claims the benefit of priority from Japanese Patent Application No. 2020-038507, filed on 6 Mar. 2020, the content of which is incorporated herein by reference.

### BACKGROUND OF THE INVENTION

### Field of the Invention The present invention relates to an information providing device.

### Related Art

Recently, the popularization of electric vehicles and hybrid vehicles equipped with secondary batteries for traveling has advanced. The onboard secondary battery mounted on an electric vehicle and the like is generally expensive. Therefore, there is a tendency for electric vehicles and the like to become expensive since the price of such a secondary battery is reflected. In order to promote the sale of electric vehicles and the like, conventionally, there has been a technique whereby a price structure composed of two rights of ownership and the usage right is provided in order to lower the sale price of electric vehicles as much as possible (for example, refer to Japanese Unexamined Patent Application, Publication No. 2010-244492). In the technique disclosed in Japanese Unexamined Patent Application, Publication No. 2010-244452, a proprietor having the ownership sets a usage right or sets a usage restriction on the usage right, thereby reducing the amount of money to be paid by a person for which the use right is established (the purchaser of the vehicle) to lower the price of the electric vehicle or the secondary battery.

Patent Document 1: Japanese Unexamined Patent Application, Publication No. 2010-244492

### SUMMARY OF THE INVENTION

If vehicles equipped with secondary batteries become more popular in the future, secondary batteries, which are common components, may fluctuate in price and affect the cost of the vehicle. In other words, the secondary battery has a possibility of creating new value by utilizing the variation of the price. It is, therefore, an object of the present disclosure to provide an information providing device capable of adding financial value to a secondary battery.

An information providing device (for example, an information providing device 200 described later) according to the present disclosure includes: a management unit (for example, a management unit 211 described later) that manages price Information relating to price of a financial product relating to a secondary battery; a first calculation unit (for example, first calculation unit 212 described later) that calculates a first price of the financial product traded on a first date based on the price information; a second calculation unit (for example, a second calculation unit 213 described later) that calculates a second price of the financial product traded on a second date based on the price information; a difference calculating unit (for example, a difference calculating unit 214 described later) that calculates a difference between the first price and the second price, and a cost determination unit (for example, a cost determination unit 215) that determines a vehicle-related cost relating to a vehicle using the secondary battery based on the difference.

Furthermore, the first calculation unit calculates the first price of the financial product purchased on the first date, and the second calculation unit calculates the second price of the financial product sold on the second date.

Furthermore, the first calculation unit calculates the first price of the financial product sold on the first date; and the second calculation unit calculates the second price of the financial product purchased on the second date.

Furthermore, the cost determination unit determines a charging cost of the vehicle using the secondary battery or a trade-in cost of the vehicle.

Furthermore, the financial product is futures.

According to the present disclosure, it is possible to provide an information providing apparatus capable of adding financial value to a secondary battery.

### BRIEF DESCRIPTION OF THE DRAWINGS

FIG. 1 is a diagram showing an example of the configuration of an information providing system according to the present embodiment;

FIG. 2 is a diagram showing an example of the configuration of the information providing device;

FIG. 3 is a diagram showing an example of futures trading of a secondary battery;

FIG. 4 is a diagram showing another example of the futures trading of the secondary battery; and

FIG. 5 is a flowchart showing processing of the information providing device.

### DETAILED DESCRIPTION OF THE INVENTION

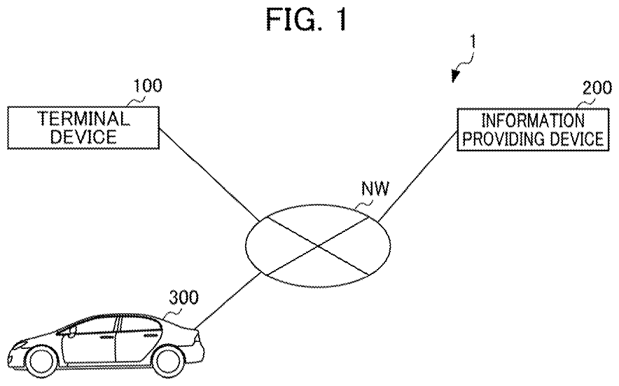

Embodiments of an information providing system of the present disclosure will be described below with reference to the drawings. FIG. 1 is a diagram showing an example of the configuration of an information providing system 1 according to the present embodiment. As shown in FIG. 1, the information providing system 1 includes a terminal device 100, an information providing device 200, and a vehicle 300.

The terminal device 100 is communicably connected to the information providing device 200 via a network NW. The terminal device 100 instructs the information providing device 200 to trade financial products.

The information providing device 200 is communicably connected to the terminal device 100 and the vehicle 300 via the network NW. The information providing device 200 receives an instruction to trade financial products from the terminal device 100.

The vehicle 300 is, for example, an electric vehicle. In the present embodiment, the vehicle 300 is assumed to be an electric vehicle. However, the vehicle 300 may be a vehicle equipped with a secondary battery for supplying power for traveling, and it may be a hybrid vehicle or a fuel cell vehicle. The vehicle 300 is communicably connected to the information providing device 200 via the network NW. The vehicle 300 receives information on vehicle-related costs relating to the vehicle using the secondary battery from the information providing device 200.

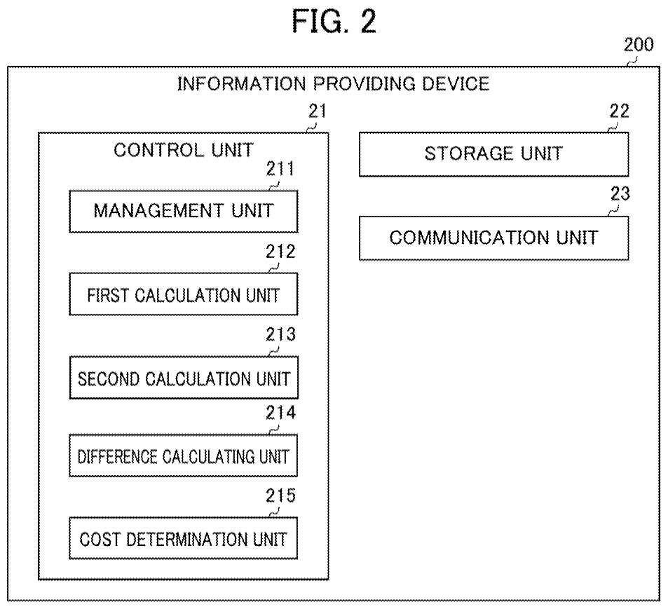

FIG. 2 is a diagram showing an example of the configuration of the information providing device 200. As shown in FIG. 2, the information providing device 200 includes a control unit 21, a storage unit 22, and a communication unit 23. The control unit 21 is realized by, for example, a hardware processor such as a CPU (Central Processing Unit) executing a program (software). Some or all of these constituent elements may be realized by hardware (including a circuit unit or circuitry) such as LSI (Large Scale Integration) or ASIC (Application Specific Integrated Circuit, FPGA (Field-Programmable Gate Array, or a GPU (Graphics Processing Unit), or may be realized by a cooperation of software and hardware. The program may be stored in advance in a storage device such as an HDD (Hard Disk Drive) or flash memory (a storage device including a non-transient storage medium), or may be stored in a removable storage medium such as a DVD or a CD-ROM (a non-transient storage medium), and installed when the storage medium is inserted to the drive device.

The storage unit 22 is realized by, for example, a storage device including a non-transient storage medium such as an HDD (Hard Disk Drive), flash memory, EEPROM (Electrically Erasable Programmable Read Only Memory), ROM (Read Only Memory), or the like, or RAM (Random Access Memory). The communication unit 23 is a communication interface for communicating with an external device such as a server 20 through the network NW.

Next, processing of the control unit 21 will be described. As shown in FIG. 2, the control unit 21 includes a management unit 211, a first calculation unit 212, a second calculation unit 213, a difference calculation unit 214, and a cost determination unit 215.

The management unit 211 manages price information relating to the price of financial products related to the secondary battery. More specifically, the management unit 211 manages price information on the price of futures in relation to the secondary battery. Here, the price information includes, for example, the identification information (ID) of the secondary battery, the model number of the secondary battery, the name and content of the material constituting the secondary battery, the futures price of the secondary battery, the manufacturing date of the secondary battery, and the like. The price information is stored in the storage unit 22 and periodically updated by the management unit 211.

Financial products may also be futures. Hereinafter, in the present embodiment, the financial product will be described as futures as an example. It should be noted that the secondary battery includes a variety of batteries such as new batteries, used batteries, batteries for automobile applications, batteries for stationary applications, and the like.

The first calculation unit 212 calculates a first price of the financial product traded on the first date based on the price information. The second calculation unit 213 calculates a second price of the financial product traded on the second date based on the price information.

More specifically, the first calculation unit 212 calculates the first price of the financial product purchased on the first date based on the price information, and the second calculation unit 213 calculates the second price of the financial product sold on the second date. As a result, the financial product (futures) of the secondary battery is purchased at the first price on the first date, and thereafter sold at the second price on the second date.

Furthermore, the first calculation unit 212 calculates the first price of the financial product sold on the first date, and the second calculation unit 213 calculates the second price of the financial product purchased on the second date. Thus, the financial product (futures) of the secondary battery is purchased at the first price on the first date, and thereafter sold at the second price on the second date.

The difference calculation unit 214 calculates a difference between the first price calculated by the first calculation unit 212 and the second price calculated by the second calculation unit 213. As a result, since the difference between the first price and the second price is calculated, it is possible to obtain the profit or loss from the trade of the financial product (futures) of the secondary battery.

The cost determination unit 215 determines a vehicle-related cost related to a vehicle using the secondary battery based on the difference. More specifically, the cost determination unit 215 determines the charging cost of the vehicle 300 using the secondary battery or the trade-in cost of the vehicle 300 as the vehicle-related cost. It should be noted that the cost determination unit 215 may use the amount obtained by subtracting a predetermined fee from the difference as the vehicle-related cost.

Thus, for example, the profit (difference) from the trade of the financial product (futures) of the secondary battery can be allocated to the charging cost of the vehicle 300 using the secondary battery or the trade-in cost of the vehicle 300. In addition, the vehicle-related cost may be costs other than the charging cost and the trade-in cost. For example, the cost may be the cost of replacing the optional parts of the vehicle 300, the cost of a smartphone application related to the vehicle 300, the service cost for the vehicle 300 such as various inspections, vehicle inspection, car washing, cleaning, and the like.

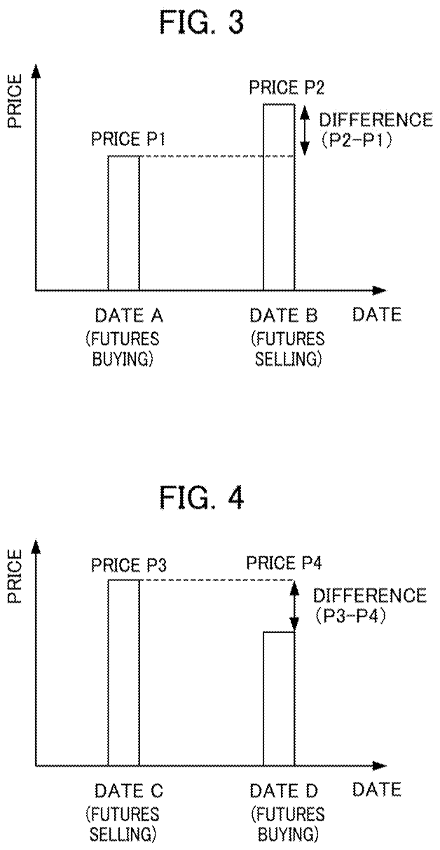

FIG. 3 is a diagram showing an example of futures trading of a secondary battery. In the example of FIG. 3, the financial product (futures) of the secondary battery is purchased at the price P1 on the date A, and thereafter sold at the price P2 on the date B.

In this example, the investor using the information providing device 200 purchases the financial product of the secondary battery at the price P1 on the date A, and thereafter purchases the vehicle 300 to which the secondary battery can be mounted. The investor then sells the financial product of the secondary battery at the price P2 on the date B. In this case, as shown in FIG. 3, since the price of the financial product of the secondary battery rises, the difference calculated by the difference calculation unit 214 becomes P2−P1, a result of which the investor can earn a profit of the difference by the trade.

The profit (difference) from the trade of the financial product (futures) of the secondary battery is allocated to the charging cost of the vehicle 300 as the vehicle-related cost determined by the cost determination unit 215, for example. This allows the investor to lower the charging cost of the vehicle 300 by the profit from the trade.

FIG. 4 is a diagram showing another example of the futures trading of the secondary battery. In the example in FIG. 4, the financial product (futures) of the secondary battery is sold at the price P3 on the date C, and thereafter purchased at the price P4 on the date D.

In this example, the investor who uses the information providing device 200 purchases the vehicle 300 to which the secondary battery can be mounted, and thereafter sells the financial product of the secondary battery at the price P1 on the date C. The investor then purchases the financial product of the secondary battery at the price P4 on the date D. In this case, as shown in FIG. 4, since the price of the financial product of the secondary battery falls, the difference calculated by the difference calculation unit 214 becomes P3−P4, the investor can earn a profit of the difference by the trade.

The profit (difference) from the trade of the financial product (futures) of the secondary battery is allocated to the trade-in cost of the vehicle 300 as the vehicle-related cost determined by the cost determination unit 215, for example. This allows the investor to make the trade-in price of the vehicle 300 high owing to the profit from the trade.

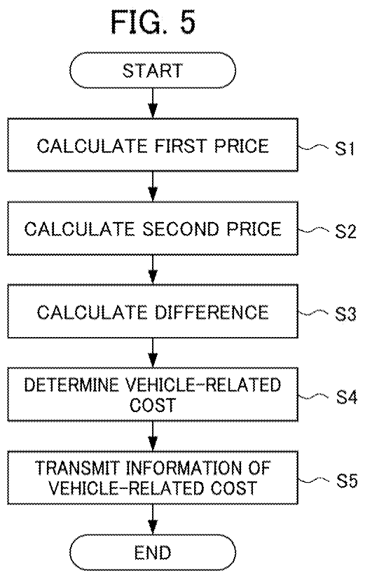

In the examples of FIGS. 4 and 5 described above, the vehicle-related cost determined by the cost determination unit 225 is the profit from the trade of the financial product of the secondary battery. However, it may be the loss from the trade of the financial product of the secondary battery.

FIG. 5 is a flowchart showing processing of the information providing device 200. In Step S1, the first calculation unit 212 calculates the first price of the financial product traded on the first date based on the price information. In Step S2, the second calculation unit 213 calculates the second price of the financial product traded on the second date based on the price information.

In Step S3, the difference calculation unit 214 calculates a difference between the first price calculated by the first calculation unit 212 and the second price calculated by the second calculation unit 213. In Step S4, the cost determination unit 215 determines, based on the difference, the vehicle-related cost relating to the vehicle using the secondary battery. In Step S5, the information providing device 200 transmits the determined vehicle-related cost information to the terminal device 100 or the vehicle 300. As a result, the information providing device 200 can notify the investor who owns the terminal device 100 or the vehicle 300 of the vehicle-related cost.

According to the present embodiment, for example, the following effects are exerted. The information providing device 200 includes: a management unit 211 that manages price information relating to price of a financial product relating to a secondary battery; a first calculation unit 212 that calculates a first price of the financial product traded on a first date based on the price information; a second calculation unit 213 that calculates a second price of the financial product traded on a second date based on the price information; a difference calculating unit 214 that calculates a difference between the first price and the second price, and a cost determination unit 215 that determines a vehicle-related cost relating to a vehicle 300 using the secondary battery based on the price difference.

As described above, the information providing device 200 determines the vehicle-related cost based on the difference between the first price and the second price of the financial product related to the secondary battery. As a result, investors buying and selling secondary batteries can obtain a vehicle-related cost in accordance with a transaction price of a financial product related to the secondary battery. Therefore, the information providing device 200 can add a new financial value to the secondary battery.

Furthermore, the first calculation unit 212 calculates the first price of the financial product purchased on the first date, and the second calculation unit 213 calculates the second price of the financial product sold on the second date. Investors buying and selling secondary batteries may benefit from vehicle-related costs by selling financial products when the price of the financial products rises after purchasing the financial products.

Furthermore, the first calculation unit 212 calculates the first price of the financial product sold on the first date; and the second calculation unit 213 calculates the second price of the financial product purchased on the second date. Investors buying and selling secondary batteries may benefit from vehicle-related costs by purchasing the financial products when the price of the financial products falls after selling the financial products.

Furthermore, the cost determination unit 215 determines a charging cost of the vehicle 300 using the secondary battery or a trade-in cost of the vehicle 300.

Furthermore, the financial product is futures. As a result, the information providing device 200 can add a new financial value to the secondary battery by performing futures trading of the financial products related to the secondary battery.

While an embodiment of the present disclosure has been described above, the present disclosure is not limited thereto. The configuration of details may be changed as appropriate within the spirit of the present disclosure.

### EXPLANATION OF REFERENCE NUMERALS

1 information providing system
21 control unit
22 storage unit
23 communication unit
24 display unit
25 operation unit
100 terminal device
200 information providing device
211 management unit
212 first calculation unit
213 second calculation unit
224 difference calculating unit
215 cost determination unit
300 vehicle

What is claimed is:

1. An information providing device comprising:
a management unit that manages price information relating to price of a financial product relating to a secondary battery;
a first calculation unit that calculates a first price of the financial product traded on a first date based on the price information;
a second calculation unit that calculates a second price of the financial product traded on a second date based on the price information;
a difference calculating unit that calculates a difference between the first price and the second price, and
a cost determination unit that determines a vehicle-related cost relating to a vehicle using the secondary battery based on the difference.

2. The information providing device according to claim 1, wherein
the first calculation unit calculates the first price of the financial product purchased on the first date, and
the second calculation unit calculates the second price of the financial product sold on the second date.

3. The information providing device according to claim 1, wherein
the first calculation unit calculates the first price of the financial product sold on the first date; and
the second calculation unit calculates the second price of the financial product purchased on the second date.

4. The information providing device according to claim 1, wherein the cost determination unit determines a charging cost of the vehicle using the secondary battery or a trade-in cost of the vehicle.

5. The information providing device according to claim 1, wherein the financial product is futures.
